(19) United States
(12) Patent Application Publication
(10) Pub. No.: US 2015/0294270 A1
(43) Pub. Date: Oct. 15, 2015

(54) SYSTEM FOR MONITORING AND REVIEWING APPLICATION ACCESS

(71) Applicant: Bank of America Corporation, Charlotte, NC (US)

(72) Inventors: Leena Mahavar, Hi Tech City, (IN); Kiran Budde, Hi Tech City (IN); Karthik K. Vadla, Hi Tech City (IN)

(73) Assignee: Bank of America Corporation, Charlotte, NC (US)

(21) Appl. No.: 14/252,957

(22) Filed: Apr. 15, 2014

(51) Int. Cl. G06Q 10/10

(52) U.S. Cl. CPC G06Q 10/105

(57) ABSTRACT

The present invention is directed to an apparatus, a method, and a computer program product for reviewing employee access within an application. A software-based tool enables a user to determine if an employee's current level of access to application functions matches an expected level of access to application functions. Modifications to the employee's level of access are recommended if it is determined that the current and expected levels of access do not match.

### BACKGROUND

There is a need to monitor and review application access of employees.

### BRIEF SUMMARY

In some embodiments, an apparatus for reviewing employee access within an application is provided. The apparatus comprises: a memory; a processor; and a module stored in memory, executable by a processor, and configured to: receive employee information, wherein the employee information includes at least an employee type and a first set of functions to which an employee currently has access; process the received employee information, wherein processing the received employee information includes comparing the first set of functions to a second set of functions to which an employee associated with the received employee type should have access; determine if the first set of functions matches the second set of functions; generate a report that includes notification that the first set of functions matches the second set of functions in response to determining that the first set of functions matches the second set of functions; and generate a report that includes at least one recommendation to modify the first set of functions in response to determining that the first set of functions does not match the second set of functions.

In some embodiments, the application is a global banking system associated with a financial institution.

In some embodiments, the first and second sets of functions include the application as a whole.

In some embodiments, the first and second sets of functions include at least one of a function, an action, a piece of information, an interface, a unit identification (ID), a display, a screen, a protocol, or a database.

In some embodiments, the employee type is at least one of processor, verifier, associate, agent, manager, specialist, or representative.

In some embodiments, processing the received employee information includes color coding the first and second sets of functions based on whether the received employee type should have access.

In some embodiments, the employee information includes at least one of a unit identification number (ID), an employee identification number (EID), a region, a super-region, a city, an employee name, a password, or a last logon date.

In some embodiments, receiving the employee information includes generating an employee profile that is associated with the employee.

In some embodiments, the employee profile is used to determine a level of access associated with the first and second sets of functions.

In some embodiments, generating the report includes transmitting the report to a second apparatus.

In some embodiments, the second apparatus is associated with a supervisor with authority to approve, deny, or execute the at least one recommendation to modify the first set of functions.

In some embodiments, the report is at least one of an email, a text message, an alert, a notification, a request form, or a spreadsheet.

In some embodiments, the report is included in a header of a message.

In some embodiments, the apparatus is configured to prompt the user via an interface to input recommendations of modifications to at least one of the first set of functions and the second set of functions to be included in the report.

In some embodiments, at least one of the first set of functions or the second set of functions are modifiable.

In some embodiments, at least one of the first set of functions or the second set of functions is modified substantially simultaneously to generating the report.

In some embodiments, the employee type is at least one of an associate, a specialist, a processor, a verifier, a manager, a reviewer, a representative, or an administrator.

In some embodiments, receiving employment information includes creating an employee profile based on the received information, wherein the employee profile is associated with the employee.

In some embodiments, a method for reviewing employee access within an application is provided. The method comprises: receiving employee information, wherein the employee information includes at least an employee type and a first set of functions to which an employee currently has access; processing the received employee information, wherein processing the received employee information includes comparing the first set of functions to a second set of functions to which an employee associated with the received employee type should have access; determining if the first set of functions matches the second set of functions; generating a report that includes notification that the first set of functions matches the second set of functions in response to determining that the first set of functions matches the second set of functions; and generating a report that includes at least one recommendation to modify the first set of functions in response to determining that the first set of functions does not match the second set of functions.

In some embodiments, a computer program product for reviewing employee access within an application is provided. The computer program product comprises: a memory; a processor; and a module stored in memory, executable by a processor, and configured to: receive employee information, wherein the employee information includes at least an employee type and a first set of functions to which an employee currently has access; process the received employee information, wherein processing the received employee information includes comparing the first set of functions to a second set of functions to which an employee associated with the received employee type should have access; determine if the first set of functions matches the second set of functions; generate a report that includes notification that the first set of functions matches the second set of functions in response to determining that the first set of functions matches the second set of functions; and generate a report that includes at least one recommendation to modify the first set of functions in response to determining that the first set of functions does not match the second set of functions.

### BRIEF DESCRIPTION OF THE DRAWINGS

Having thus described embodiments of the invention in general terms, reference will now be made to the accompanying drawings, where:

FIG. 1 is an exemplary process flow illustrating a process for monitoring and reviewing application access, in accordance with embodiments of the present invention;

FIG. 2 is an exemplary user interface for displaying incoming employee information, in accordance with embodiments of the present invention;

FIG. 3A is an exemplary user interface for displaying employee information sorted by geography, in accordance with embodiments of the present invention;

FIG. 3B is an exemplary user interface for displaying employee information sorted by employee type and function, in accordance with embodiments of the present invention;

FIG. 3C is an exemplary user interface for displaying employee information sorted by region and unit, in accordance with embodiments of the present invention;

FIG. 4 is an exemplary user interface for comparing function sets, in accordance with embodiments of the present invention;

FIG. 5 is an exemplary block diagram illustrating technical components of a system for monitoring and reviewing application access, in accordance with embodiments of the present invention;

### DETAILED DESCRIPTION OF THE PRESENT INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

The present invention is directed to a software-based tool (e.g., an apparatus) that enables a user (e.g., an administrator, an associate, an agent, a manager, an internal operations specialist, an information technology specialist, or the like) to efficiently monitor and review employee access to various functions, interfaces, screens, forms, actions, and information (collectively referred to herein as “functions”) within an application. The apparatus is configured to help the user identify which employees (e.g., customer service representatives, bank tellers, internal operations specialists, information technology specialists, or other agents associated with the entity) should have access to particular functions within the application. The user can then recommend modifications to a supervisor so that any errors in access are appropriately remedied. The purpose of the apparatus is to provide an automated system of monitoring and reviewing access to various functions of the application and, ultimately, the apparatus is used to promote correct distribution of authority and access across the application.

In some embodiments, the application is a global banking system used by multiple employees across the entity to process, collect, or service various payments or requests. The global banking system typically includes a plurality of functions necessary to processing a wide variety of service requests. In other embodiments, the application is a financial application, an online banking application, an automated teller machine (ATM), or another type of application associated with the entity.

More specifically, the apparatus may be used to monitor and review employee access to functions within the application. For example, an employee dedicated to processing loan service requests requires access to all functions associated with processing loan service requests. Conversely, the employee dedicated to processing loan service requests would not require access to functions that are not associated with processing loan service requests (e.g., functions associated with processing an online banking balance inquiry or another process that is determined to be outside of a scope associated with the employee's role).

Access to the application or functions within the application is typically determined based on a role associated with the employee, namely an employee type. The apparatus may be configured to identify the role, position, title, job, sector, or group associated with the employee. For example, the employee may be determined to be a customer service representative dedicated to processing loan service requests located in a particular office dedicated to servicing a financial group. The employee type may be determined by other factors, such as responsibilities or job functions associated with the employee.

Typically there are two employee types—processors and verifiers. Processors (e.g., associates, agents, or the like) are responsible for processing requests and executing functions or actions based on the request. Verifiers (e.g., managers, reviewers, or the like) are responsible for maintaining a substantially satisfactory level of quality amongst the processors' output. In alternative embodiments, other employee types exist.

Different employee types have access to different sets or groups of functions within the application. For example, processors have access to one set of functions, while verifiers have access to a second set of functions. Some functions may be present in both sets of functions (e.g., a function may be included in each of the set of functions accessed by processors and the set of functions accessed by verifiers).

Functions may be further grouped based on region, super-region (e.g., a continent), a city, a state, a country, a zip code, an office location, an Internet Protocol (IP) address, global positioning system (GPS) coordinates, longitude and latitude, or another geographical identifier. For example, if it is known to the entity that an office dedicated to processing loan service requests is located in Region 1, then all employees in Region 1 may be granted access to a suite of functions within the application that enable the employees to process loan service requests. Conversely, access may be restricted to a second suite of functions within the application that do not pertain to processing loan service requests.

Access to various functions within the application may also be determined based upon a combination of employee type, geographical identifiers, and other types of employee information. For example, the apparatus may be configured to profile the employee such that information associated with the employee, the role of the employee or employee type, geographical identifiers associated with the employee, or the like is retrieved, aggregated, and processed to determine an employee profile to associate with the employee. The determined employee profile may be processed by the apparatus to determine an appropriate level of access to a plurality of functions within a suite of functions associated with a global banking application.

The apparatus may be configured to associate the determined level of access to one or more functions with the employee or the employee profile. Therefore, when the user monitors or reviews access to functions (e.g., processes the employee profile), the user can easily identify to which functions the employee currently has access, currently does not have access, should have access, and should not have access. In some embodiments, full access to a function is granted to the employee. For example, the employee may have read and write access to a function. In other embodiments, partial access to a function is granted to the employee. For example, the employee may have read-only access to a function. In alternative embodiments, employee access to a function is fully restricted. For example, the employee may not have read or write access to a function.

Based on this processing, the user can clearly communicate to a supervisor who has authority the status of function or application access of the employee. Furthermore, the user may recommend to the supervisor an action to correct any identified errors in employee access to one or more functions. In some embodiments, the user has authority to modify or approve the modification of employee access. In other embodiments, the user does not have such authority and may be required to send a recommendation to the supervisor for modifications to employee access.

The apparatus may be configured to generate a report that summarizes current employee access as compared to expected employee access. The apparatus may generate a form, an email, a chart, a table, a spreadsheet, text, a message, or another form of communication that includes information associated with employee access. The apparatus may further be configured to transmit the generated report or the raw information itself to a second user, a supervisor, an employee, or a third party for review. The generated report may include comments or recommendations for modifying employee access.

The apparatus may further include a search function for effectively locating employee information, a function, or another piece of information associated with the application.

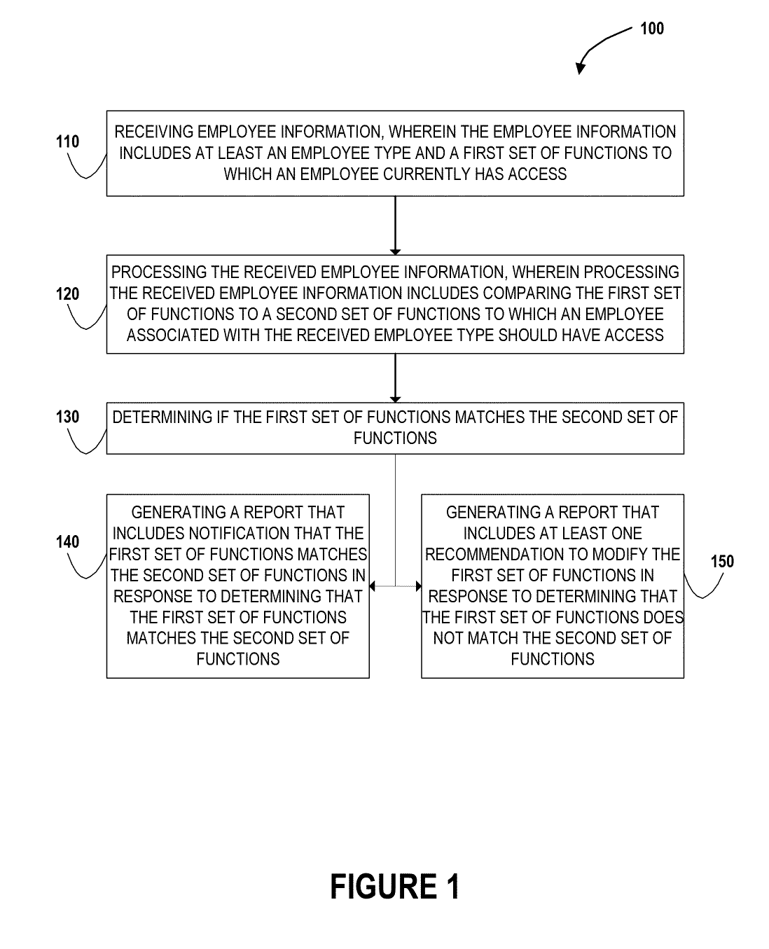

Referring now to the Figures, FIG. 1 illustrates an exemplary process flow 100 for monitoring and reviewing application access. At block 110 the process includes receiving receive employee information, wherein the employee information includes at least an employee type and a first set of functions to which an employee currently has access. At block 120 the process includes processing the received employee information, wherein processing the received employee information includes comparing the first set of functions to a second set of functions to which an employee associated with the received employee type should have access. At block 130 the process includes determining if the first set of functions matches the second set of functions. At block 140 the process includes generating a report that includes notification that the first set of functions matches the second set of functions in response to determining that the first set of functions matches the second set of functions. At block 150 the process includes generating a report that includes at least one recommendation to modify the first set of functions in response to determining that the first set of functions does not match the second set of functions.

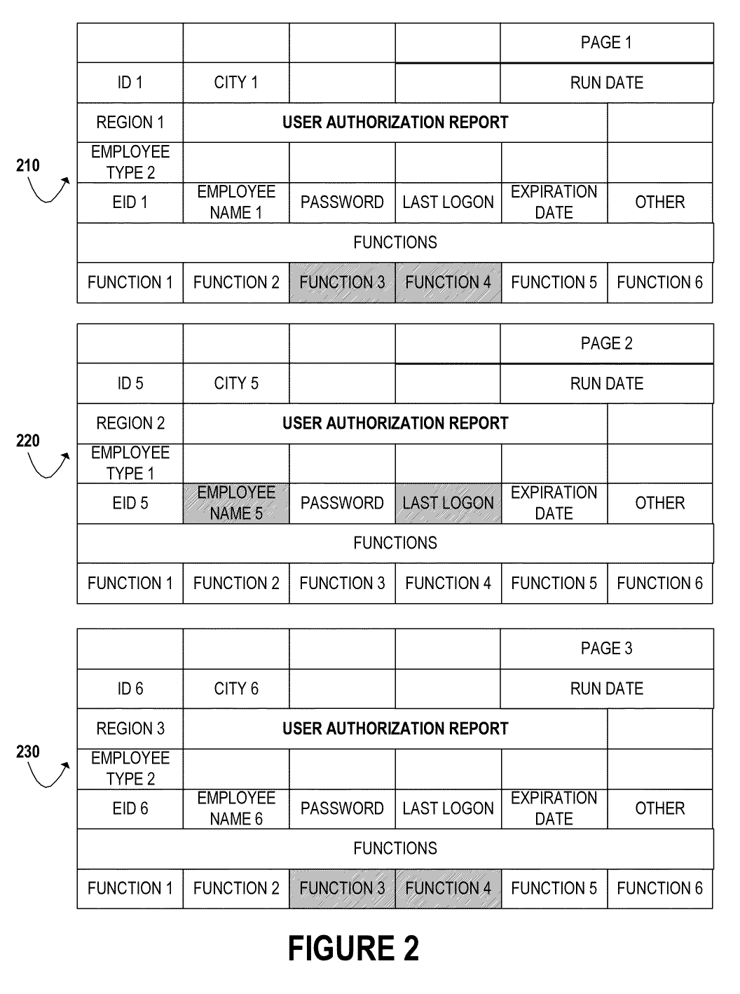

FIG. 2 illustrates an exemplary user interface for displaying incoming employee information. The apparatus is configured to receive employee information as defined above via one of several ways. In some embodiments, the employee information may be retrieved by the apparatus from a database or datastore associated with the application or the entity. The entity may maintain such a database to keep records of all employees and employee profiles. In other embodiments, the employment information may be received by the apparatus from a second apparatus. For example, a second apparatus associated with a third party who is responsible for maintaining a database of employment information that is associated with the entity may transmit the employment information to the apparatus in response to receiving a request for employment information, at various predetermined time intervals, or for other reasons. In alternative embodiments, the employment information may be received by the apparatus from a legal entity onboarding (LEO) security system.

FIG. 2 depicts three different employee profiles 210, 220, 230 associated with three different employees. The employee profiles include information associated with the employee and may include information associated with the employee such as an employee name, an employee type, an employee identification number (EID), a unit identification (ID) number, a city, a region, a super-region, a username, a password, an expiration date of commission or authority associated with the entity, logon times and information, or other personal information. Further, the employee profiles include one or more functions that the employee currently is able to access. These accessible functions may be listed by name, a function identifier or function code, and may be color coded for ease of identification. As seen in employee profiles 210, 220, 230, the highlighted functions are the functions that each employee currently is able to access. The apparatus may store the received employee information in a database or simply input it into a form for display and processing.

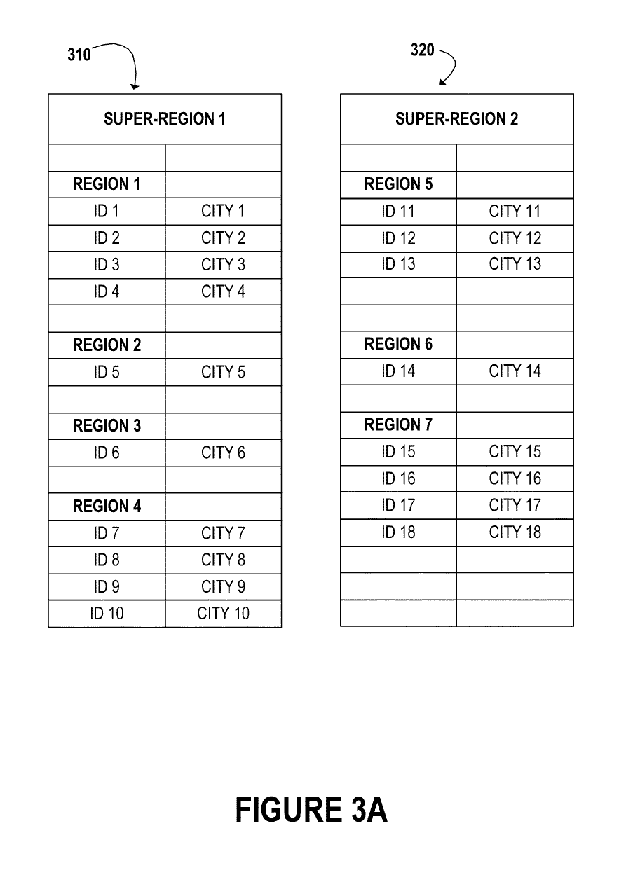

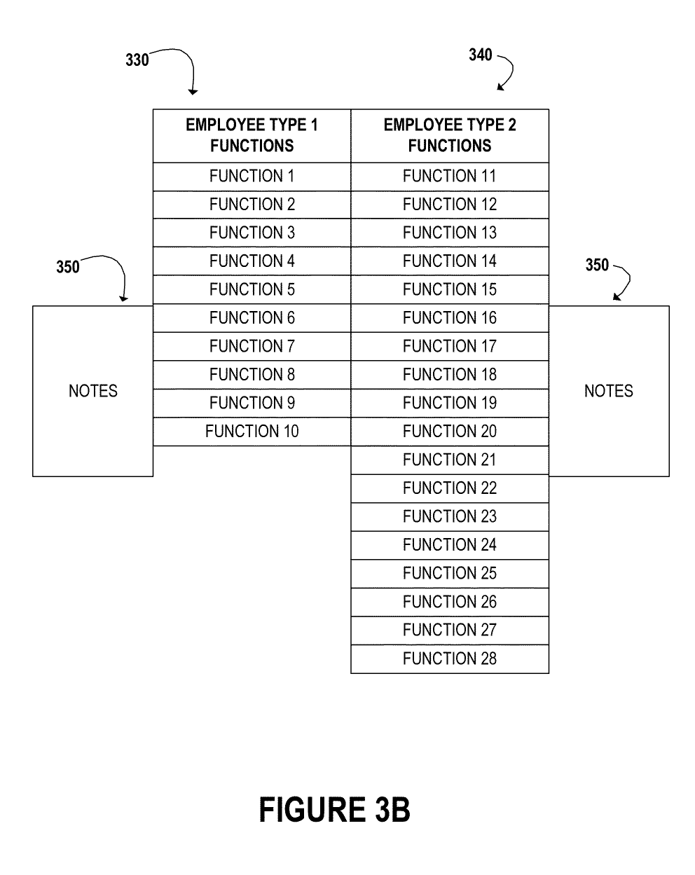

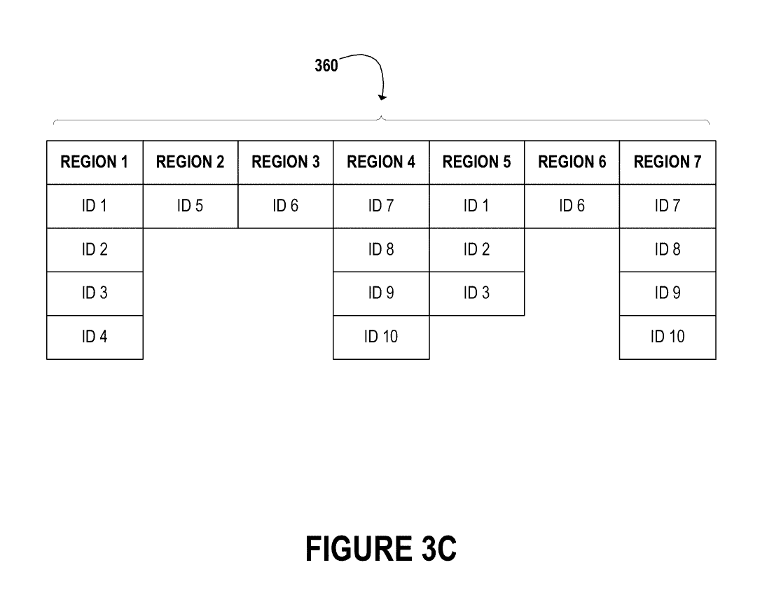

Typically the received employee information is inputted by the apparatus into a common form (e.g., a spreadsheet or workbook) comprising the exemplary user interfaces in FIGS. 3A, 3B, and 3C. However, for image clarity reasons, the common form has been split into three separate Figures. The employee information may be arranged, organized, or displayed in a variety of manners.

FIG. 3A is an exemplary user interface for displaying employee information sorted by geography. The interfaces in FIG. 3A enable the user to clearly see how geography affects the grouping of employees and employee types, as well as the functions accessible by these employees and employee types. Super-regions 1 and 2 310, 320 include a visual breakdown of how each region is organized. Each region may be organized by unit identification (ID) number, which may correspond to an office location. Each ID may also correspond to a city. As disclosed above, functions may be deemed accessible to some or all employees within a particular office location, ID, city, region, super-region, or another geographic identifier.

FIG. 3B is an exemplary user interface for displaying employee information sorted by employee type and function. As stated above, the employee information includes an employee type, as well as functions accessible by each employee type. As seen in FIG. 3B, different employee types may have access to different sets of functions, depending on the duties required by the role of each employee type. For example, processors (employee type 1) 330 have a more limited set of accessible functions than that of verifiers (employee type 2) 340 due to processors having a different level of authority than verifiers. Furthermore, each employee type typically has access to the functions that are required for employees of each employee type to properly fulfill their respective duties. Certain functions may be independent to one employee type or may be shared by multiple employee types. Additionally, notes 350 may be included in the employee information. The Notes 350 may pertain to either or both of the employee types and/or their associated functions.

FIG. 3C is an exemplary user interface for displaying employee information sorted by region and unit. The employee information displayed in the interface in FIG. 3C sorts the unit IDs based on region.

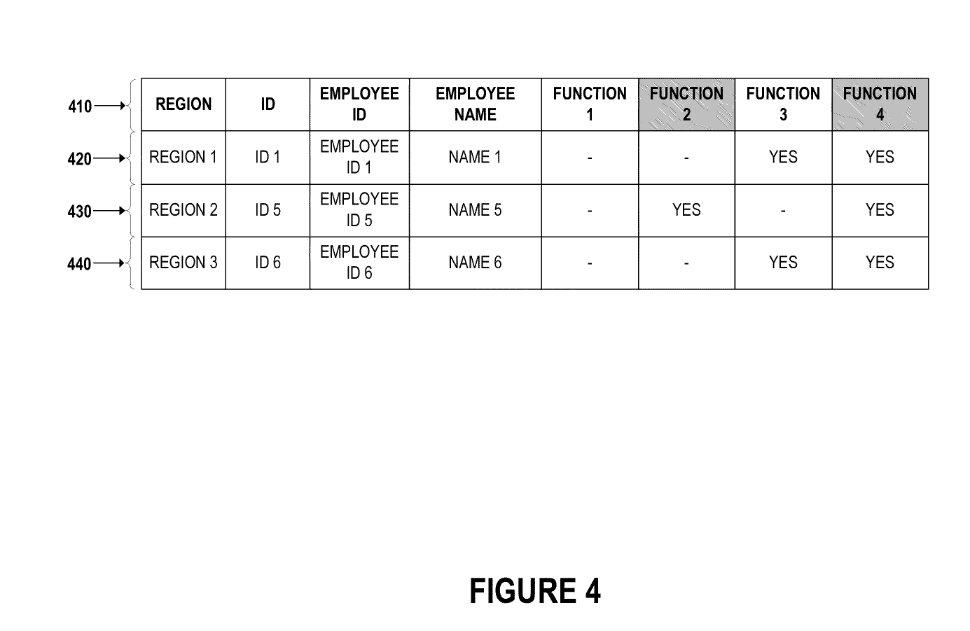

FIG. 4 is an exemplary user interface for comparing function sets. The apparatus inputs the received employee information into an interface as seen in FIG. 4 that enables the user to visually compare levels of access to various functions across a plurality of employees. Headers 410 provide column labels for the employee information inputted into the interface. The employee information may include a region, an ID, an EID, an employee name, an employee type, a city, or another piece of information associated with an employee 420, 430, 440.

Further, the headers 410 include a list of functions. These functions may or may not be accessible by each employee 420, 430, 440 being compared. The functions may be color coded to denote if they should be accessible to the employees 420, 430, 440 being compared. For example, as shown in FIG. 4, Function 2 and Function 4 are shaded (colored) because they are functions that should be accessible to each of the employees 420, 430, 440. Conversely, Function and Function 3 are not shaded (white) because they should not be accessible to each of the employees 420, 430, 440. Other notification means may be used to signal if one of the listed functions should be accessible to each of the employees 420, 430, 440 based on employee type, job function, region, unit ID, or another piece of employee information.

The imported employee information for each employee 420, 430, 440 may be displayed in a row respective to each employee 420, 430, 440. The apparatus may, after receiving and processing the employee information, be configured to denote which of the functions listed in the header 410 are currently accessible to each employee 420, 430, 440. For example, as shown in FIG. 4, a dash listed underneath Function 1 in the header 410 is used to denote that each of the employees 420, 430, 440 currently do not have access to Function 1. Conversely, a “YES” listed underneath Function 4 in the header 410 is used to denote that each of the employees 420, 430, 440 currently do have access to Function 4. Alternative means for denoting if the employees 420, 430, 440 do or do not currently have access to functions may be used, such as a check, an “X,” or the like.

The user may review the listed function accessibilities of each of the employees 420, 430, 440. In some embodiments, the user may manually or visually review employee access to the functions. In other embodiments, the apparatus may be configured to review employee access to the functions.

Current employee access to functions is compared to the expected employee access based on each of the employees' 420, 430, 440 employee information. A comparison interface such as the one in FIG. 4 may be used to identify incorrectly assigned employee access to functions, or the application as a whole. The user may be enabled via the interface to toggle, set, modify, change, edit, add, flag, monitor, or delete access to functions for each of the employees 420, 430, 440.

In some embodiments, actual changes in employee access may take effect in the application substantially simultaneously to the user selecting, toggling, or modifying the functions associated with each employee 420, 430, 440 via the interface in FIG. 4. In other embodiments, changes in employee access may require additional authorization by a supervisor or administrator who is authorized to review, approve, deny, or modify proposed changes to employee access.

After the user (or the apparatus) substantially completes the review of employee access to functions for each of the employees 420, 430, 440, the apparatus may prompt the user with a form or an interface for creating a report of the completed review. In some embodiments, the report embodies an email, a text document, a spreadsheet, a text message, a notification, an alert, a request-for-supervisory-approval form, or another form of communication. The report may summarize any changes or modifications to employee access that have been flagged by the user during review. The report may also be included in a header of one of the aforementioned forms of communication.

In some embodiments, the apparatus is configured to transmit the report to a second apparatus associated with an administrator or supervisor for review. The apparatus may transmit the report to the second apparatus wirelessly or via a wireline. In other embodiments, the report may be stored in memory for later recall. In alternative embodiments, the report may be printed out onto paper, or may be transmitted to a second application for review or further processing.

The user or a second user (e.g., a supervisor) may be enabled via the apparatus to override or modify restrictions on employee access on a per-function basis. For example, an employee may require access to a function outside a standard set of functions assigned to an employee type associated with the employee. The user may be enabled to manually override the access restriction for the employee so that the employee has access to the function outside the standard set of functions in addition to the standard set of functions. The user may further be enabled to customize or select which functions the employee can access.

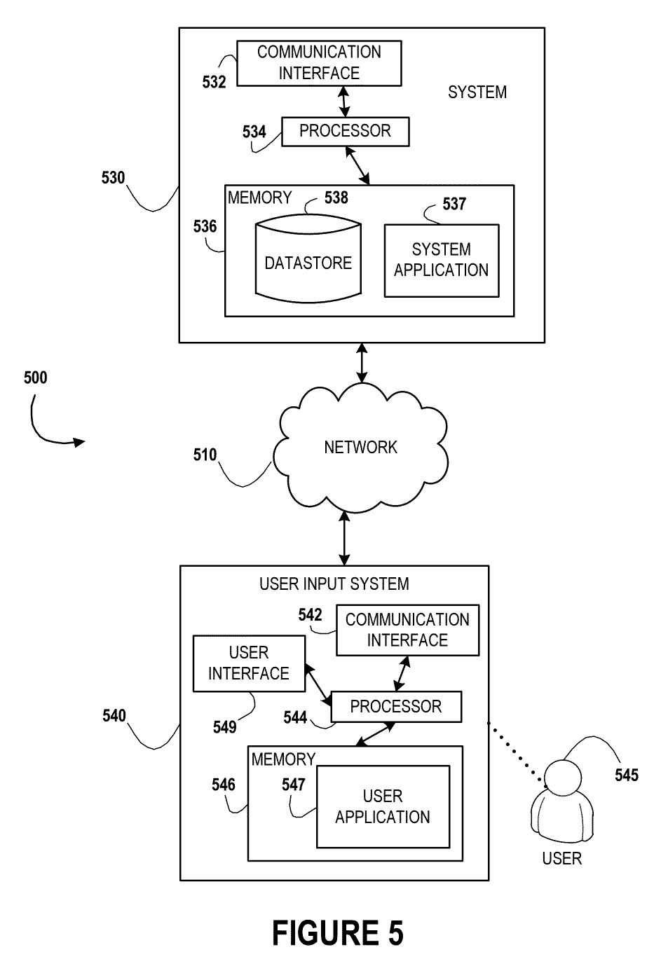

FIG. 5 is an exemplary block diagram illustrating technical components of a system 500 for monitoring and reviewing application access as described in the process flow described in FIG. 1 and the exemplary interfaces in FIGS. 2-4. As illustrated, the system environment 500 includes a network 510, a system 530, and a user input system 540. Also shown in FIG. 5 is a user 545 of the user input system 540. The user input system 540 may be any computing device. The user 545 may be a person who uses the user input system 540 to execute a user application 547. The user application 547 may be an application to communicate with the system 530, perform a transaction, input information onto a user interface presented on the user input system 540, or the like. The user application 547 and/or the system application 537 may incorporate one or more parts of any process flow described herein.

As shown in FIG. 5, the system 530, and the user input system 540 are each operatively and selectively connected to the network 510, which may include one or more separate networks. In addition, the network 510 may include a telecommunication network, local area network (LAN), a wide area network (WAN), and/or a global area network (GAN), such as the Internet. It will also be understood that the network 510 is secure and may also include wireless and/or wireline and/or optical interconnection technology.

The user input system 540 may include any computerized apparatus that can be configured to perform any one or more of the functions of the user input system 540 described and/or contemplated herein. For example, the user 545 may use the user input system 540 to transmit and/or receive information or commands to and from the system 530. In some embodiments, for example, the user input system 540 may include a personal computer system (e.g. a non-mobile or non-portable computing system, or the like), a mobile computing device, a personal digital assistant, a mobile phone, a tablet computing device, a network device, and/or the like. As illustrated in FIG. 5, in accordance with some embodiments of the present invention, the user input system 540 includes a communication interface 542, a processor 544, a memory 546 having a user application 547 stored therein, and a user interface 549. In such embodiments, the communication interface 542 is operatively and selectively connected to the processor 544, which is operatively and selectively connected to the user interface 549 and the memory 546. In some embodiments, the user 545 may use the user application 547 to execute processes described with respect to the process flow and interfaces described herein. Specifically, the user application 547 executes the process flow described in FIG. 1.

Each communication interface described herein, including the communication interface 542, generally includes hardware, and, in some instances, software, that enables the user input system 540, to transport, send, receive, and/or otherwise communicate information to and/or from the communication interface of one or more other systems on the network 510. For example, the communication interface 542 of the user input system 540 may include a wireless transceiver, modem, server, electrical connection, and/or other electronic device that operatively connects the user input system 540 to another system such as the system 530. The wireless transceiver may include a radio circuit to enable wireless transmission and reception of information. Each processor described herein, including the processor 544, generally includes circuitry for implementing the audio, visual, and/or logic functions of the user input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 547 of the memory 546 of the user input system 540.

Each memory device described herein, including the memory 546 for storing the user application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the user application 547. In some embodiments, the user application 547 includes an interface for communicating with, navigating, controlling, configuring, and/or using the user input system 540. In some embodiments, the user application 547 includes computer-executable program code portions for instructing the processor 544 to perform one or more of the functions of the user application 547 described and/or contemplated herein. In some embodiments, the user application 547 may include and/or use one or more network and/or system communication protocols.

Also shown in FIG. 5 is the user interface 549. In some embodiments, the user interface 549 includes one or more output devices, such as a display and/or speaker, for presenting information to the user 545. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 545. In some embodiments, the user interface 549 includes the input and display devices of a mobile device, which are operable to receive and display information.

FIG. 5 also illustrates a system 530, in accordance with an embodiment of the present invention. The system 530 may refer to the “apparatus” described herein. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. Therefore, the system 530 may be a server managed by the entity. The system 530 may be located at the facility associated with the entity or remotely from the facility associated with the entity. In some embodiments, such as the one illustrated in FIG. 5, the system 530 includes a communication interface 532, a processor 534, and a memory 536, which includes a system application 537 and a datastore 538 stored therein. As shown, the communication interface 532 is operatively and selectively connected to the processor 534, which is operatively and selectively connected to the memory 536.

It will be understood that the system application 537 may be configured to implement any one or more portions of the various user interfaces and/or process flow described herein. The system application 537 may interact with the user application 547. It will also be understood that, in some embodiments, the memory includes other applications. It will also be understood that, in some embodiments, the system application 537 is configured to communicate with the datastore 538, the user input system 540, or the like.

It will be further understood that, in some embodiments, the system application 537 includes computer-executable program code portions for instructing the processor 534 to perform any one or more of the functions of the system application 537 described and/or contemplated herein. In some embodiments, the system application 537 may include and/or use one or more network and/or system communication protocols.

In addition to the system application 537, the memory 536 also includes the datastore 538. As used herein, the datastore 538 may be one or more distinct and/or remote datastores. In some embodiments, the datastore 538 is not located within the system and is instead located remotely from the system. In some embodiments, the datastore 538 stores information or data described herein.

It will be understood that the datastore 538 may include any one or more storage devices, including, but not limited to, datastores, databases, and/or any of the other storage devices typically associated with a computer system. It will also be understood that the datastore 538 may store information in any known way, such as, for example, by using one or more computer codes and/or languages, alphanumeric character strings, data sets, figures, tables, charts, links, documents, and/or the like. Further, in some embodiments, the datastore 538 may include information associated with one or more applications, such as, for example, the system application 537. It will also be understood that, in some embodiments, the datastore 538 provides a substantially real-time representation of the information stored therein, so that, for example, when the processor 534 accesses the datastore 538, the information stored therein is current or substantially current.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. It will also be understood that the system 530 may include and/or implement any embodiment of the present invention described and/or contemplated herein. For example, in some embodiments, the system 530 is configured to implement any one or more of the embodiments of the process flows described and/or contemplated herein in connection any process flow described herein. Additionally, the system 530 or the user input system 540 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for reviewing employee access within an application, the apparatus comprising:
a memory;
a processor; and
a module stored in memory, executable by a processor, and configured to:
receive employee information, wherein the employee information includes at least an employee type and a first set of functions to which an employee currently has access;
process the received employee information, wherein processing the received employee information includes comparing the first set of functions to a second set of functions to which an employee associated with the received employee type should have access;
determine if the first set of functions matches the second set of functions;
generate a report that includes notification that the first set of functions matches the second set of functions in response to determining that the first set of functions matches the second set of functions; and
generate a report that includes at least one recommendation to modify the first set of functions in response to determining that the first set of functions does not match the second set of functions.

2. The apparatus of claim 1, wherein the application is a global banking system associated with a financial institution.

3. The apparatus of claim 2, wherein the first and second sets of functions include the application as a whole.

4. The apparatus of claim 1, wherein the first and second sets of functions include at least one of a function, an action, a piece of information, an interface, a unit identification (ID), a display, a screen, a protocol, a or a database.

5. The apparatus of claim 1, wherein the employee type is at least one of processor, verifier, associate, agent, manager, specialist, or representative.

6. The apparatus of claim 1, wherein processing the received employee information includes color coding the first and second sets of functions based on whether the received employee type should have access.

7. The apparatus of claim 1, wherein the employee information includes at least one of a unit identification number (ID), an employee identification number (EID), a region, a super-region, a city, an employee name, a password, or a last logon date.

8. The apparatus of claim 1, wherein receiving the employee information includes generating an employee profile that is associated with the employee.

9. The apparatus of claim 8, wherein the employee profile is used to determine a level of access associated with the first and second sets of functions.

10. The apparatus of claim 1, wherein generating the report includes transmitting the report to a second apparatus.

11. The apparatus of claim 10, wherein the second apparatus is associated with a supervisor with authority to approve, deny, or execute the at least one recommendation to modify the first set of functions.

12. The apparatus of claim 1, wherein the report is at least one of an email, a text message, an alert, a notification, a request form, or a spreadsheet.

13. The apparatus of claim 12, wherein the report is included in a header of a message.

14. The apparatus of claim 1, wherein the apparatus is configured to prompt the user via an interface to input recommendations of modifications to at least one of the first set of functions and the second set of functions to be included in the report.

15. The apparatus of claim 1, wherein at least one of the first set of functions or the second set of functions are modifiable.

16. The apparatus of claim 15, wherein at least one of the first set of functions or the second set of functions is modified substantially simultaneously to generating the report.

17. The apparatus of claim 1, wherein the employee type is at least one of an associate, a specialist, a processor, a verifier, a manager, a reviewer, a representative, or an administrator.

18. The apparatus of claim 1, wherein receiving employment information includes creating an employee profile based on the received information, wherein the employee profile is associated with the employee.

19. A method for reviewing employee access within an application, the method comprising:
receiving employee information, wherein the employee information includes at least an employee type and a first set of functions to which an employee currently has access;
processing the received employee information, wherein processing the received employee information includes comparing the first set of functions to a second set of functions to which an employee associated with the received employee type should have access;
determining if the first set of functions matches the second set of functions;
generating a report that includes notification that the first set of functions matches the second set of functions in response to determining that the first set of functions matches the second set of functions; and
generating a report that includes at least one recommendation to modify the first set of functions in response to determining that the first set of functions does not match the second set of functions.

20. A computer program product for reviewing employee access within an application, the computer program product comprising:
a memory;
a processor; and
a module stored in memory, executable by a processor, and configured to:
receive employee information, wherein the employee information includes at least an employee type and a first set of functions to which an employee currently has access;
process the received employee information, wherein processing the received employee information includes comparing the first set of functions to a second set of functions to which an employee associated with the received employee type should have access;
determine if the first set of functions matches the second set of functions;
generate a report that includes notification that the first set of functions matches the second set of functions in response to determining that the first set of functions matches the second set of functions; and
generate a report that includes at least one recommendation to modify the first set of functions in response to determining that the first set of functions does not match the second set of functions.
